(19) United States
(12) Patent Application Publication
(10) Pub. No.: US 2014/0082838 A1
(43) Pub. Date: Mar. 27, 2014

(54) Adjustable Transfer Assist Standbar

(71) Applicant: Karl HAYWARD, Dade City, FL (US)

(72) Inventor: Karl HAYWARD, Dade City, FL (US)

(73) Assignee: U.S. Department of Veterans Affairs, Washington, DC (US)

(21) Appl. No.: 14/022,532

(22) Filed: Sep. 10, 2013

Related U.S. Application Data
(60) Provisional application No. 61/744,353, filed on Sep. 25, 2012.

(51) Int. Cl. A61G 5/14

(52) U.S. Cl. CPC A61G 5/14
USPC 5/81.1 R

(57) ABSTRACT

A device for assisting a person in a standing or sitting position, or switching between sitting and standing positions, includes an elongated member with free first and second end portions, and a middle portion. The middle portion includes a plurality of sections extending at an angle relative to one another. A hinge member is disposed between the first and second end portions. One of the free first and second end portions is adapted to be mounted to a support in a manner that the other of the first and second end portions is selectively disposed adjacent to or away from the support by operation of the hinge member.

### CROSS-REFERENCE TO RELATED APPLICATIONS

The present application claims priority on prior U.S. Provisional Application Ser. No. 61/744,353, filed Sep. 25, 2012, which is hereby incorporated herein in its entirety by reference.

### STATEMENT REGARDING FEDERALLY SPONSORED RESEARCH OR DEVELOPMENT

The work leading to the present invention was made with Government support, and specifically by an employee of the U.S. Department of Veterans Affairs. The U.S. Government, therefore, has certain rights in the invention.

### FIELD AND BACKGROUND OF THE INVENTION

The present invention is generally directed to therapeutics, and more particularly to a device for assisting a person in a standing or sitting position, or switching between sitting and standing positions.

Parallel bars are an important tool in the process of gait, transfer, and balance training. The psychological benefits of being able to stand and balance without the assistance of a caregiver are sometimes overlooked. This ability can improve a patient's confidence, self-image, public image, and an overall sense of well-being. As therapists, we should always aim to restore maximum independence to all facets of an individual's lifestyle. With this in mind, I have developed a transfer assist standbar.

### ASPECTS AND BRIEF SUMMARY OF THE INVENTION

The present disclosure is directed to various aspects of the present invention.

One aspect of the present invention is to provide a device for assisting a person in a standing or sitting position, or switching between sitting and standing positions.

Another aspect of the present invention is to provide a device that allows a person to balance himself or herself without assistance, when standing, or pulling up from a sitting position, particularly in a wheelchair or the like.

Another aspect of the present invention is to provide a device that provides a variety of strength/balance training opportunities, such as sit-to-stand transfer, shallow knee bend, weight shift/bearing, posture alignment standing/sitting, pre-gait training, balance challenge, and the like.

Another aspect of the present invention is to provide a device that can be useful in decreasing tone/spasm and, therefore, in improving posture/balance.

Another aspect of the present invention is to provide a device that is especially useful for patients having unilateral upper extremity function/support, and particularly those with mild to severe hypertonia resulting in decreased balance.

Another aspect of the present invention is to provide a device that can be used in assisting a person with brain injury, spinal cord injury, strokes, and various debility issues.

Another aspect of the present invention is to provide a device that provides a person the advantage and stability of a parallel bar, and which can be deployed or used anywhere.

Another aspect of the present invention is to provide a device that is adjustable to accommodate individual balance challenges and/or deficits.

Another aspect of the present invention is to provide a device that can be installed on a wheelchair or other mobile transport device unilaterally or bilaterally, and is removable for transport or plain ease and comfort.

Another aspect of the present invention is to provide a device for assisting a person in a standing or sitting position, or switching between sitting and standing positions, which includes an elongated member having free first and second end portions, and a middle portion. The middle portion includes a plurality of sections extending at an angle relative to one another. A hinge member is disposed between the first and second end portions. One of the free first and second end portions is adapted to be mounted to a support, and wherein when one of the free first and second end portions is mounted to the support, the other of the first and second end portions can be selectively disposed adjacent to or away from the support by operation of the hinge member.

Another aspect of the present invention is to provide a device for assisting a person in a standing or sitting position, or switching between sitting and standing positions, which includes an elongated bar having a proximal portion adapted for mounting to a support, a distal portion, and a middle portion. The middle portion includes a horizontally extending section. A hinge member is disposed between the proximal and distal portions. The distal portion extends substantially at a right angle to the horizontally extending section, and wherein when the proximal portion is mounted to the support, the distal portion selectively extends vertically and substantially parallel to the proximal portion, or at angle thereto by operation of the hinge member.

Another aspect of the present invention is to provide a device in combination with a wheelchair or personal mobility device or vehicle, for assisting a person in a standing or sitting position, or switching between sitting and standing positions. The device includes an elongated bar having a proximal portion adapted for mounting to a wheelchair or personal mobility device or vehicle, a distal portion, and a middle portion. The middle portion includes a horizontally extending section. A hinge member is disposed between the proximal and distal portions. The distal portion extends substantially at a right angle to the horizontally extending section, and wherein when the proximal portion is mounted to the wheelchair or personal mobility device or vehicle, the distal portion selectively extends vertically and substantially parallel to the proximal portion, or at angle thereto by operation of the hinge member.

In summary, the device or standbar of the present invention can be attached to any power wheelchair or the like, and provides an individual with the safety and stability. The standbar is a significant tool in the process of pre-gait, transfer, balance, strength, and stability training. The standbar provides stability and increased ability to individuals who are challenged with cognitive deficits as a result of combat trauma. The standbar also provides a reduction in the level of supervision or physical assist required by a family member or caregiver in the activities mentioned above. The psychological benefit of being able to safely stand, balance, and converse with others at eye level without the assistance of a caregiver is immeasurable. This ability can improve individual confidence, self-image, public image, and overall sense of well-being through increased independence.

The unique and innovative features of the standbar that distinguish it from traditional parallel bar systems, are at least as follows:
The standbar is mobile because it is attached to an individual's power wheelchair. This feature enables the standbar to be used anywhere at any time. For instance in the home, at a friend or family member's home, when traveling, or in the park, etc.
The standbar is lightweight and can be deployed by the user, repositioned, or removed with one hand. The standbar can be positioned and secured as a parallel bar or repositioned as a lap bar for added security when sitting. standbars can be fitted to a power wheelchair unilateral or bilateral to accommodate individual needs. This ability is made possible because the mount/receiving tube is designed to accommodate mounting on either side of the wheelchair.
The standbar has a traditional horizontal hand grip (FIG. 3), but is improved with the addition of a vertical staff hand grip. The vertical grip feature (FIG. 3) increases the ability of an individual, who presents with weakness or trunk flexor hypertonia to assume a more upright posture in stance due to a more comfortable and effective hand position. The vertical grip will benefit those individuals who find it easier to pull themselves to a standing position as opposed to a traditional armrest or push bar. The safe hand grip transition, from vertical to horizontal position, is made possible by a smooth, preferably six inch radial bend in the bar (FIG. 3). Therefore, hand contact with the bar is never compromised. This feature is extremely important in the process of developing an individual's confidence in their own balance and stability.
The standbar is adjustable in height and reach. The height is adjusted by repositioning a through bolt, up or down, in the receiving tube (FIG. 4) or using the High/Low seat positioning function on the power wheelchair, if available. The reach is adjusted by repositioning the mount/receiving tube, forward or backward, on the power wheelchair mounting rail.
The mobility and vertical grip options of the standbar make it a unique assistive device in providing independence to those who need it most.

### BRIEF DESCRIPTION OF THE DRAWINGS

One of the above and other aspects, novel features and advantages of the present invention will become apparent from the following detailed description of the non-limiting preferred embodiment(s) of invention, illustrated in the accompanying drawings, wherein:

FIG. 1 is a side perspective view of a preferred embodiment of the device of the present invention;

FIG. 2 is an isometric view of a second embodiment of the device of the present invention;

FIG. 3 is a view similar to FIG. 2, showing the device without the receiving tube;

FIG. 4 is an enlarged view of the receiving tube of FIG. 2, shown without the mounting plate;

FIG. 5 is an enlarged view of the mounting plate shown in FIG. 2;

FIG. 6 is a perspective view showing the device of FIG. 1 mounted on a wheelchair;

FIG. 7 is an enlarged view showing the mounting details of the device shown in FIG. 6;

FIG. 8 is a view similar to FIG. 6, showing being used by a person;

FIGS. 9A-B are views similar to FIG. 8, showing a pull-to-stand transfer from a sitting position;

FIG. 10 is a view similar to FIG. 8, showing the use of the device of the present invention in a standing position;

FIG. 11 is a view similar to FIG. 10, showing safe hand grip transition from the vertical portion of the device to a horizontal weight bearing portion;

FIG. 12 is a view similar to FIG. 11, showing the use of the horizontal weight bearing portion of the device;

FIG. 13 is an isometric view of a third embodiment of the device of the present invention, showing the adjustability aspect in phantom lines; and

FIG. 14 is a view similar to FIG. 2, showing an optional feature.

### DETAILED DESCRIPTION OF THE PREFERRED EMBODIMENT(S) OF THE INVENTION

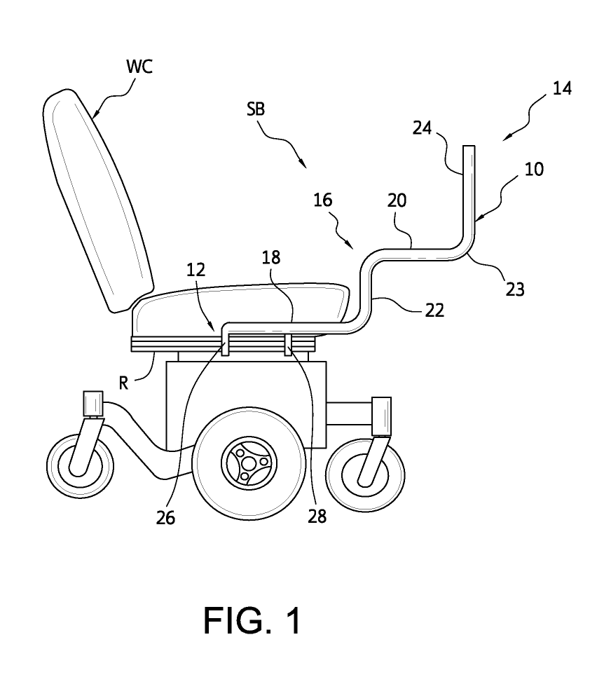

As best illustrated in FIG. 1, the device SB of the present invention, conveniently referred to herein as standbar, includes a generally elongated bar 10 with a proximal end portion 12, a distal end portion 14, and a middle portion 16. As illustrated, the middle portion 16 is generally S-shaped and includes generally horizontally extending sections 18 and 20 connected by a generally vertically extending section 22. Preferably, the proximal and distal end portions 12 and 14, and the sections 18, 20 and 22, extend at a right angle to one another. It is noted, however, that is within the scope of the present invention to have the proximal and distal end portions 12 and 14, and the sections 18, 20 and 22, extend at various other angles.

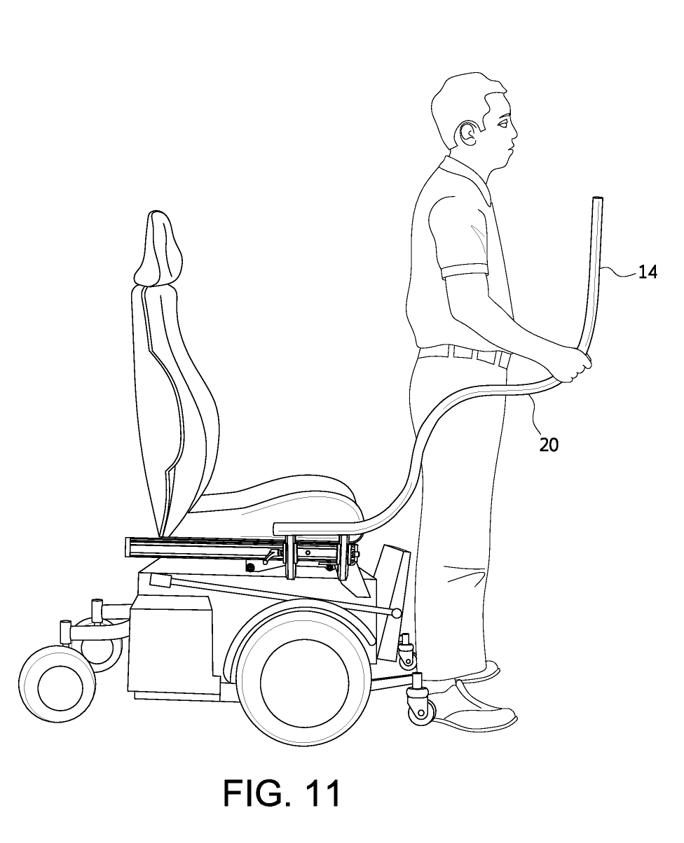

A radial bend 23, positioned between the distal end portion 14 and the horizontal section 20, allows for a smooth, safe hand grip transition therebetween (FIG. 11).

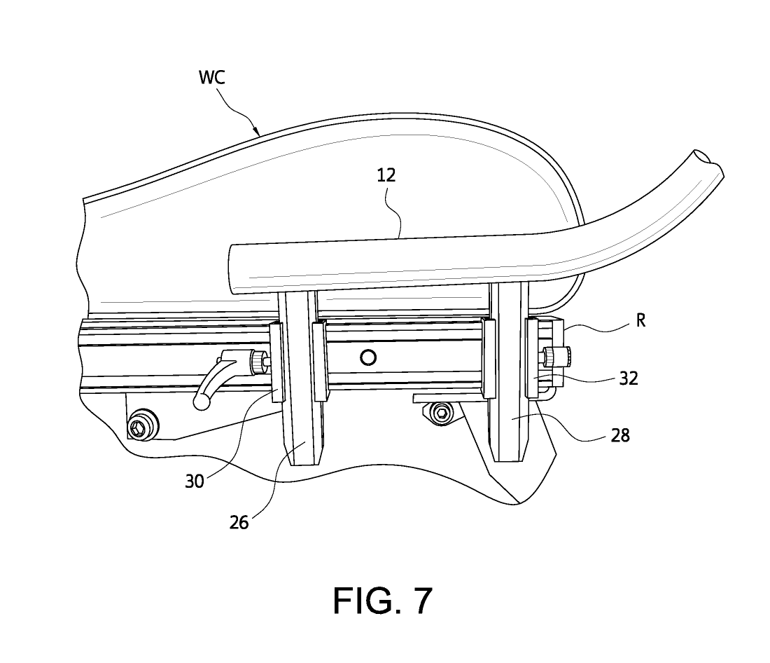

The distal end portion 14 includes a free end 24, while the proximal end portion 12 is adapted to be mounted to a support that can be a wheelchair, an ambulatory device or vehicle, a person transport device or vehicle, or a personal mobility device or vehicle, or the like. As illustrated in FIGS. 1 and 7, the proximal end portion 12 is mounted to a rail R of a wheelchair WC.

In particular, as best shown in FIG. 7, preferably two stabilizing bars 26 and 28, provided on the proximal end portion 12, are slidably received in corresponding brackets 30 and 32 on the rail R.

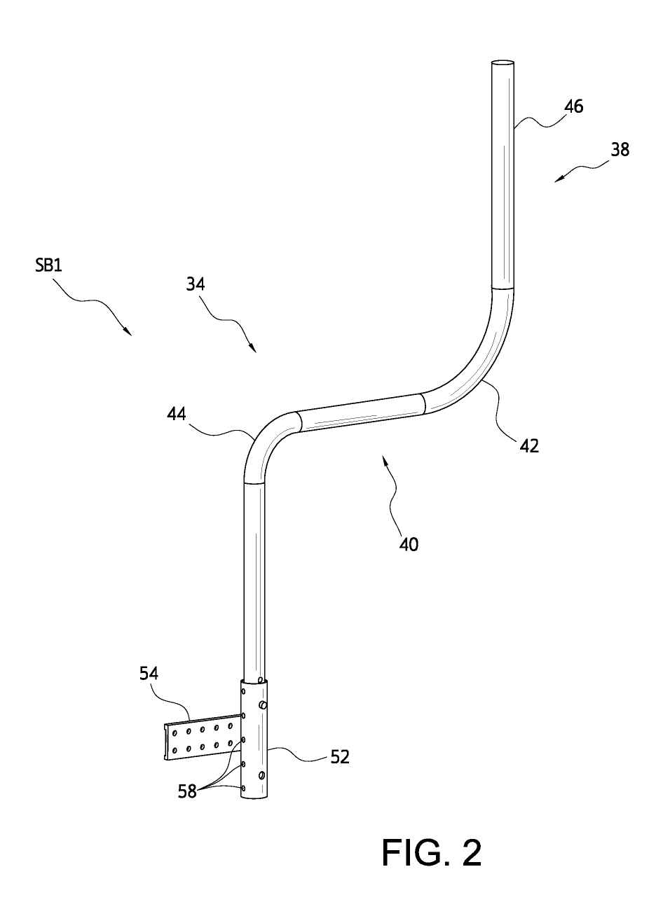

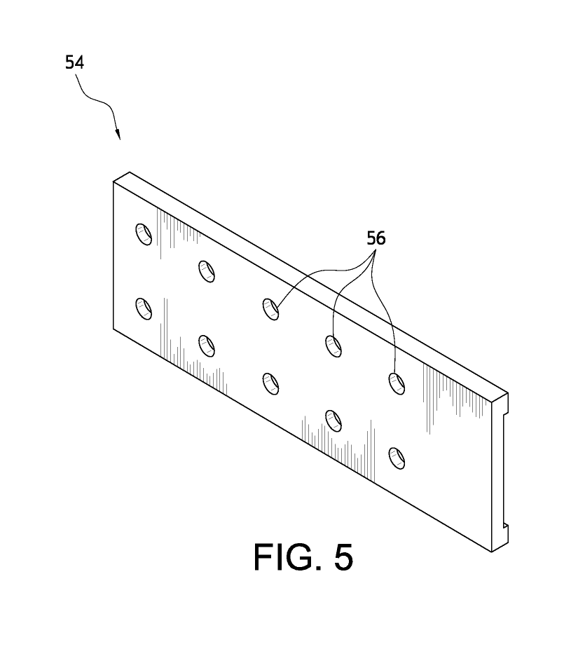

A second embodiment of the standbar SB1 will now be described by referring to FIGS. 2-5. The standbar SB1 includes an elongated bar 34 with a proximal end portion 36, a distal end portion 38, and a middle portion 40. Preferably, the elongated bar 34 (or 10) is cylindrical and hollow in configuration to accommodate, for example, wiring and the like items or other accessories.

The middle portion 40 extends, preferably at a right angle to the distal end portion 38, as well as to the proximal end portion 36. A transitional, and preferably smooth radial bend 42 is formed between the distal end portion 38 and the middle portion 40. Likewise, a somewhat shorter radial bend 44 is interposed between the proximal end portion 36 and the middle portion 40. The distal end portion 38 includes a free end 46, while the proximal end portion 36 is provided with a plurality of height adjustment set screw holes 48 that cooperate with the set screw holes 50 in a receiving tube 52, described below in more detail. As best shown in FIGS. 2 and 4-5, the receiving tube 52 has a mounting plate 54 attached thereto.

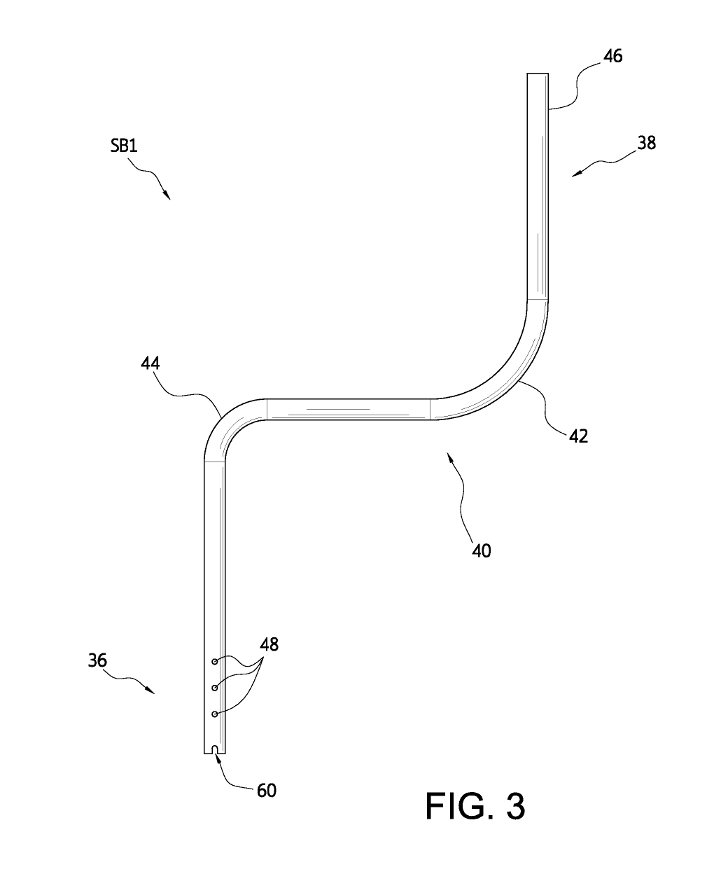

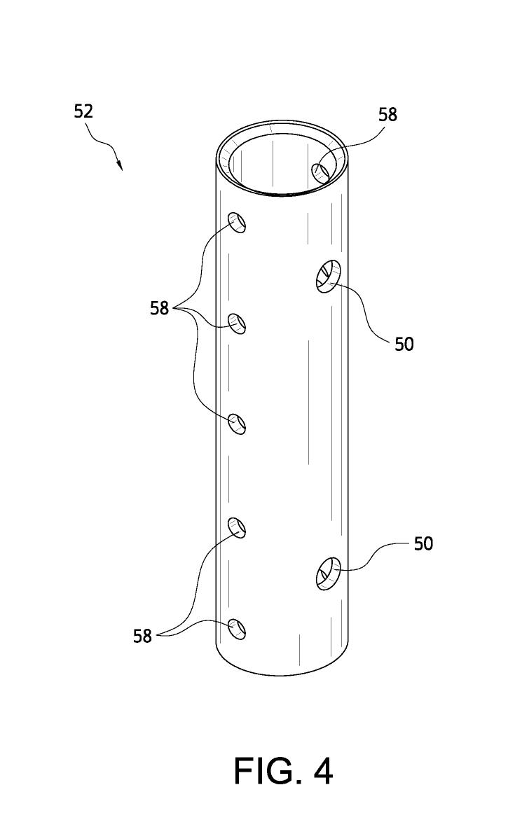

The mounting plate 54 is dimensioned and configured to be attached to a wheelchair WC or the like and includes mounting holes 56 for receiving the screws or the like fasteners (not shown). As noted above, the receiving tube 52 is provided with height adjustment holes 50 that receive a set screw for height adjustment purposes (see FIG. 4). The receiving tube 52 is further provided with a row of preferably five through holes 58 on each side thereof (only the complete left row is shown in FIG. 4) for receiving a through bolt (not shown) that cooperates with two of four positioning channels 60 disposed circumferentially at about 90° from each other on the proximal end portion 36 of the standbar SB1 (FIG. 3).

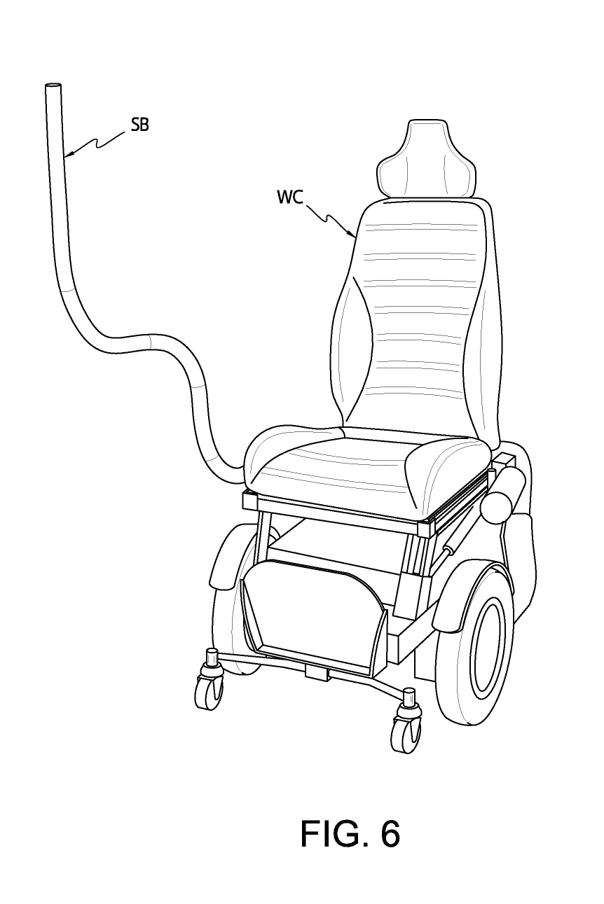

As illustrated in FIG. 6, the standbar SB (or SB1) can be mounted on any one side of the wheelchair WC, or on both sides, depending upon the needs of the individual.

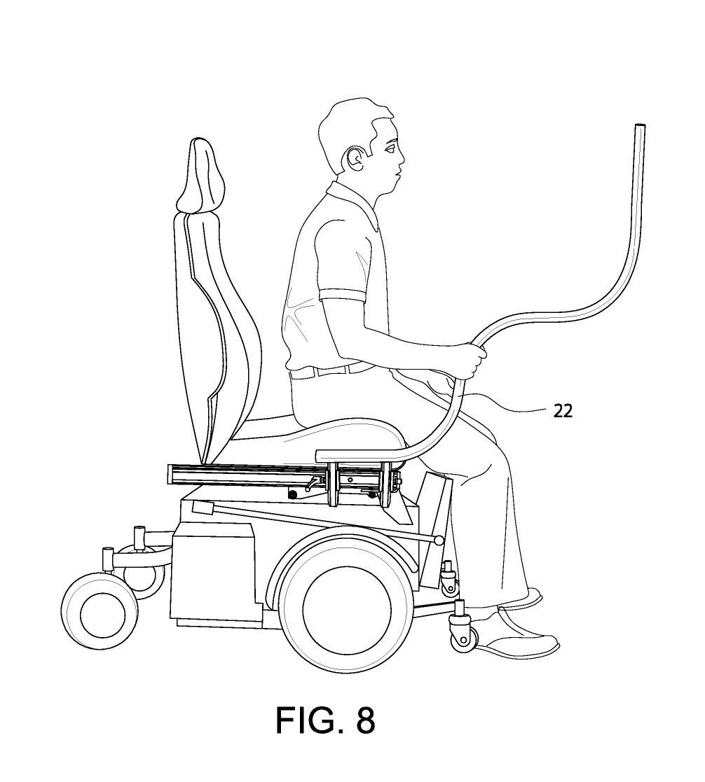

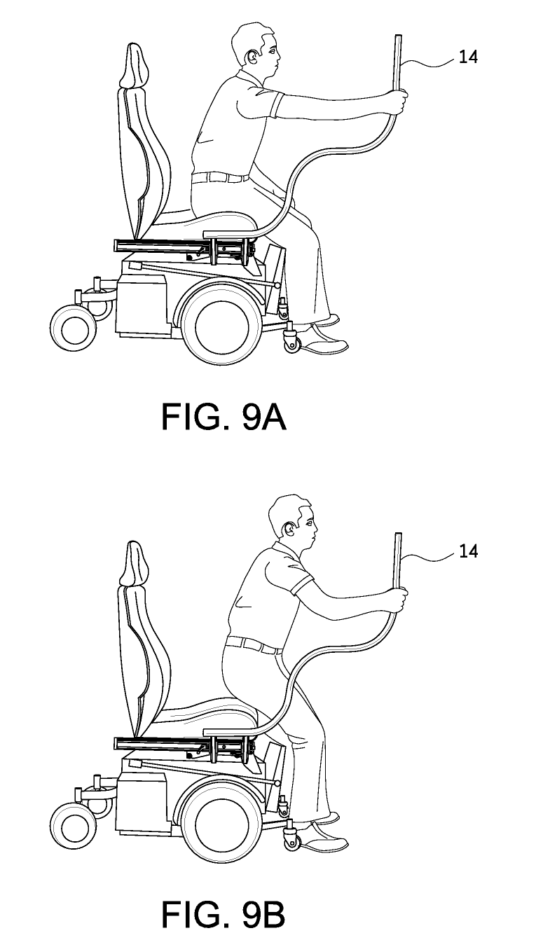

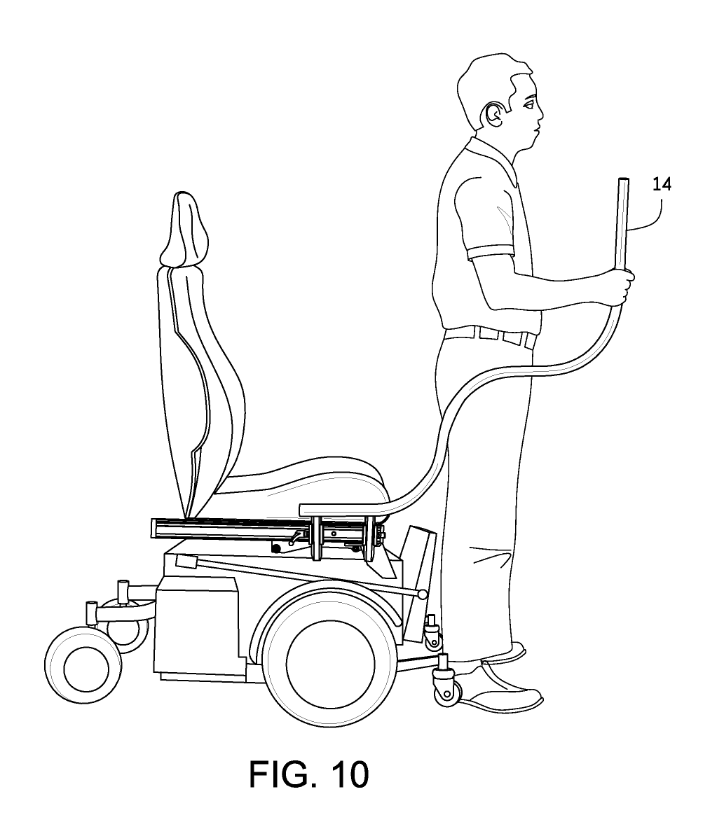

As illustrated in FIG. 8, the person simply grabs the vertical section 22 for support in a seated position. When the person desires to stand up from the sitting position, he simply stretches his hand out to grab the farthest positioned distal end portion 14 (FIG. 9A) that allows him to pull himself up (FIG. 9B) and transfer to a standing position (FIG. 10) directly in front of the wheelchair WC.

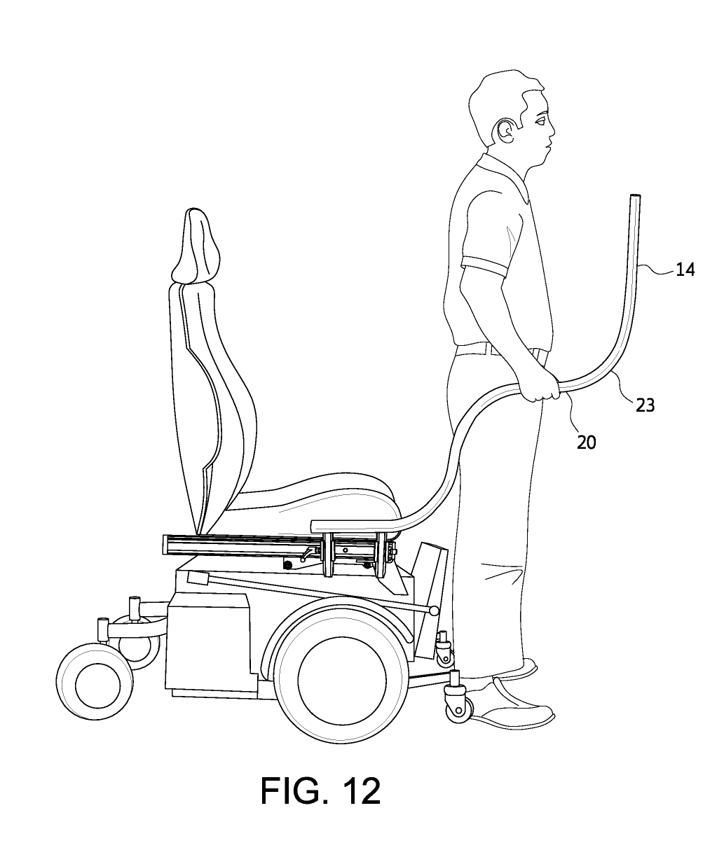

As illustrated in FIGS. 11-12, the radial bend 42 provides a safe and comfortable had grip transition between the distal vertical portion 14 and the horizontal section 20.

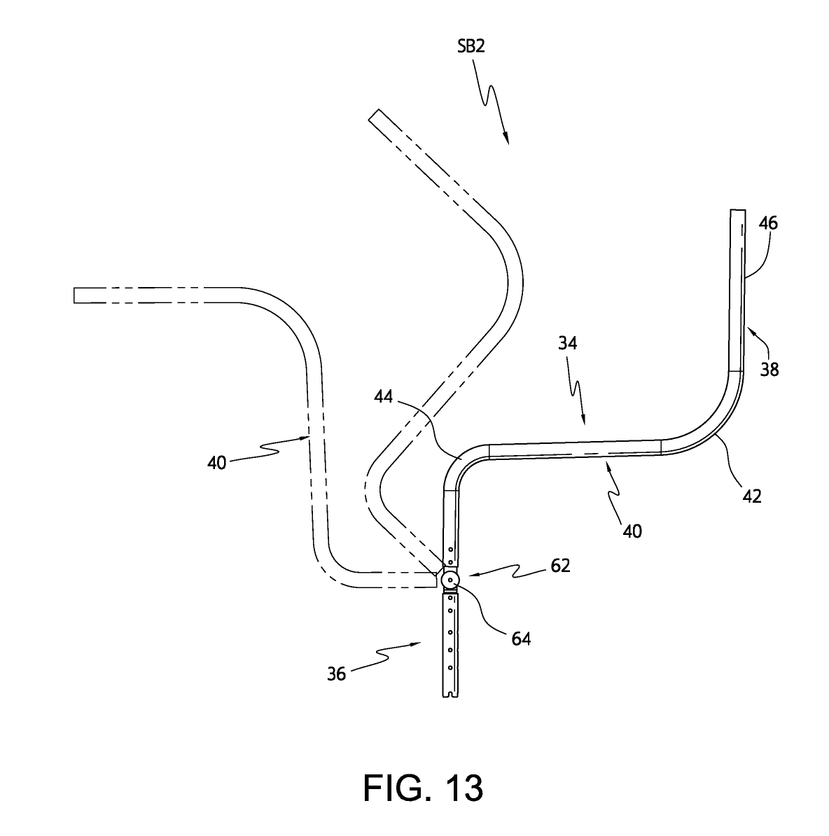

A third embodiment of the standbar SB2, which is similar to the second embodiment SB1, will now be described by referring to FIG. 13. As shown, a hinge joint 62 is provided adjacent the proximal end portion 36. The hinge joint 62 is preferably a heavy-duty alloy steel locking hinge that allows for positive locking at any 10° increment with upto at least 220° inline rotation range of motion. Once locked, the hinge becomes a rigid joint, able to withstand upto at least 1200 inch-lbs. of torque.

The joint 62 enables the horizontal aspect (middle portion 40—see the leftmost portion of FIG. 13 in phantom lines) of the standbar SB2 to be repositioned vertical/posterior and close to the individual (or as necessary) requiring assistance for easy hand grasp on the standbar SB2, while remaining in contact with the backrest. The benefit of this option is magnified when cognitive issues require caregiver assistance with positioning or securing an individual's hands on the bar. The caregiver can now use the standbar SB2 as a lever to assist the individual with positioning anterior/forward over their knees and feet prior to performance of a sit to stand transfer. The hinge joint 62 enables the standbar SB2 to be repositioned forward in increments of 10 degrees by pressing a joint release button 64 on the lateral aspect of the hinge 62 (FIG. 13). This incremental adjustability will aid in accommodating individuals with issues of tone, spasticity, or retropulsion. Once the standbar SB2 is repositioned in standard anterior deployment, the individual with hands secured on the horizontal aspect should be positioned properly to perform a sit to stand transfer. The incremental hinge joint option standbar SB2 can then be used in reverse order to facilitate return to sitting, if necessary.

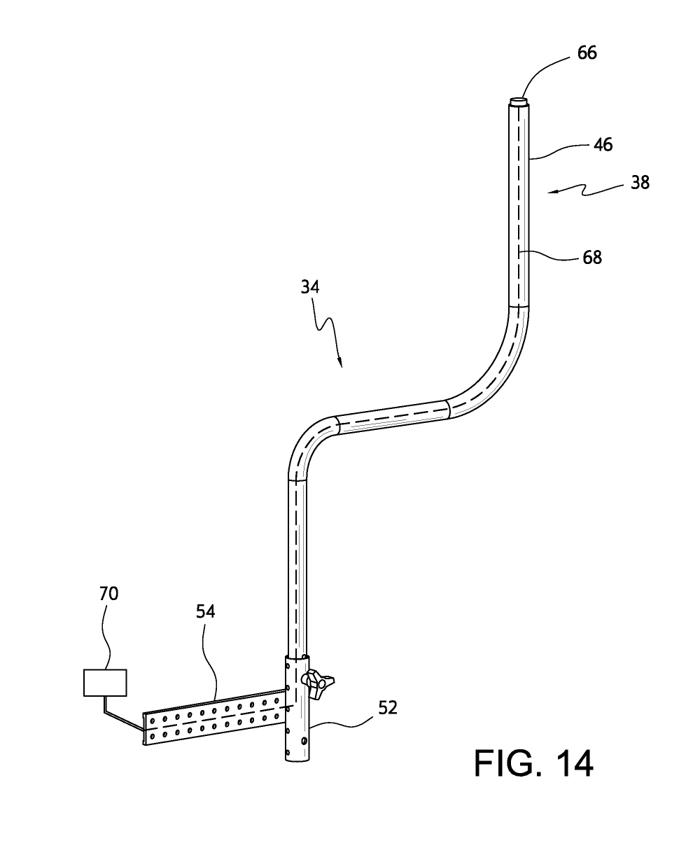

FIG. 14 illustrates an alternative for the standbar SB (or SB1 or SB2) of the invention. As noted above, the elongated bar 34 (or 10) is preferably hollow in configuration to accommodate wiring or other accessories. As shown in FIG. 14, a HI/LO function switch 66 may be installed, preferably at the top of the free end 46 of the distal end portion 38. Suitable wiring 68 would extend through the bar 34 (or 10), from the switch 66 to a conventional power source/function box 70 that is generally a part of the wheelchair WC. The HI/LO switch 66 feature would allow the user to accommodate HI/LO power chair height adjustments, while standing.

While this invention has been described as having preferred sequences, ranges, steps, order of steps, materials, structures, symbols, indicia, graphics, color scheme(s), shapes, configurations, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the claims appended hereto or presented later. The invention, therefore, is not limited to the preferred embodiment(s) shown/described herein.

What is claimed is:

1. A device for assisting a person in a standing or sitting position, or switching between sitting and standing positions, comprising:
a) an elongated member having free first and second end portions, and a middle portion;
b) said middle portion including a plurality of sections extending at an angle relative to one another;
c) a hinge member disposed between said first and second end portions;
d) one of said free first and second end portions adapted to be mounted to a support; and
e) wherein when said one of said free first and second end portions is mounted to the support, the other of said first and second end portions can be selectively disposed adjacent to or away from the support by operation of said hinge member.

2. The device of claim 1, wherein:
a) two of said sections extend substantially at a right angle to each other.

3. The device of claim 1, wherein:
a) said middle portion is generally S-shaped.

4. The device of claim 1, wherein:
a) when said one of said free first and second end portions is mounted to the support, one of said sections extends generally horizontally and another said sections extends generally vertically therefrom.

5. The device of claim 4, wherein:
a) said vertically extending section is disposed farthest from the support.

6. The device of claim 1, wherein:
a) when said one of said free first and second end portions is mounted to the support, at least two of said sections extend generally horizontally and at least two of said sections extends generally vertically.

7. The device of claim 6, wherein:
a) at least one of said vertically extending sections is disposed farthest from the support.

8. The device of claim 1, wherein:
a) the length of at least one of said sections is variable.

9. The device of claim 1, wherein:
a) said hinge member allows for incremental angular adjustment between said first and second end portions.

10. The device of claim 1, wherein:
a) said elongated member comprises a generally cylindrical bar.

11. A device for assisting a person in a standing or sitting position, or switching between sitting and standing positions, comprising:
a) an elongated bar having a proximal portion adapted for mounting to a support, a distal portion, and a middle portion;
b) said middle portion including a horizontally extending section;
c) a hinge member disposed between said proximal and distal portions;
d) said distal portion extending substantially at a right angle to said horizontally extending section; and
e) wherein when said proximal portion is mounted to the support, the distal portion selectively extends vertically and substantially parallel to said proximal portion, or at angle thereto by operation of said hinge member.

12. The device of claim 11, wherein:
a) said distal portion includes a free end portion.

13. The device of claim 12, further comprising:
a) a radial bend section between said distal portion and said horizontally extending section.

14. The device of claim 11, wherein:
a) the length of said proximal portion is variable.

15. The device of claim 11, wherein:
a) the length of said middle portion is variable.

16. The device of claim 11, wherein:
a) said elongated bar is generally cylindrical in configuration.

17. The device of claim 11, wherein:
a) said hinge member allows for incremental angular adjustment between said proximal and distal portions.

18. The device of claim 11, wherein:
a) the support comprises a wheelchair, an ambulatory device or vehicle, a person transport device or vehicle, or a personal mobility device or vehicle.

19. In combination with a wheelchair or personal mobility device or vehicle, a device for assisting a person in a standing or sitting position, or switching between sitting and standing positions, the device comprising:
a) an elongated bar having a proximal portion adapted for mounting to the wheelchair or personal mobility device or vehicle, a distal portion, and a middle portion;
b) said middle portion including a horizontally extending section;
c) a hinge member disposed between said proximal and distal portions;
d) said distal portion extending substantially at a right angle to said horizontally extending section; and
e) wherein when said proximal portion is mounted to the wheelchair or personal mobility device or vehicle, the distal portion selectively extends vertically and substantially parallel to said proximal portion, or at angle thereto by operation of the hinge member.
